(19) United States
(12) Patent Application Publication
(10) Pub. No.: US 2021/0339750 A1
(43) Pub. Date: Nov. 4, 2021

(54) Methods and Systems for Tracking an Object

(71) Applicant: Aptiv Technologies Limited, St. Michael (BB)

(72) Inventors: Marek Jacek Szlachetka, Sulkowice (PL); Kamil Leonard Ostrowski, Kicin (PL)

(21) Appl. No.: 17/242,201

(22) Filed: Apr. 27, 2021

(30) Foreign Application Priority Data
Apr. 29, 2020 (EP) 20172208.9

(51) Int. Cl. B60W 40/04; B60W 50/00

(52) U.S. Cl. CPC B60W 40/04; G01S 13/723; B60W 50/0097

(57) ABSTRACT

A computer implemented method for tracking an object comprises the following steps carried out by computer hardware components: upon first detection of the object, assigning a first parameter to the object; carrying out a prediction of a state of the object; determining whether a second parameter is to be assigned to the object; carrying out re-initialization of the state of the object responsive to determining the first parameter is assigned to the object; and carrying out an update of the state of the object responsive to determining the second parameter is assigned to the object.

### CROSS-REFERENCE TO RELATED APPLICATION

This application claims priority to European Patent Application Number 20172208.9, filed Apr. 29, 2020, the disclosure of which is hereby incorporated by reference in its entirety herein.

### BACKGROUND

The present disclosure relates to methods and systems for tracking an object. Tracking objects, for example determining and updating the location of an object, the heading angle of an object, and/or the type of an object (for example car, truck, bicycle, pedestrian, building, or static road obstacle), is essential for at least partially autonomously driving vehicles. Accordingly, there is a need to provide reliable and efficient object tracking.

### SUMMARY

The present disclosure provides a computer implemented method, a computer system, a vehicle, and a non-transitory computer readable medium according to the independent claims. Embodiments are given in the subclaims, the description and the drawings.

In one aspect, the present disclosure is directed at a computer implemented method for tracking an object, the method comprising the following steps performed (in other words: carried out) by computer hardware components: upon first detection of the object, assigning a first parameter to the object; carrying out a prediction of a state of the object; determining whether a second parameter is to be assigned to the object; carrying out re-initialization of the state of the object in response to determining the first parameter is assigned to the object; and carrying out an update of the state of the object in response to determining the second parameter is assigned to the object.

In other words, object tracking may be improved with re-initialization and adding a further status (in other words: second parameter) to allow additional measurements to be made with filtering updates (in other words: to allow re-initialization).

Tracking an object may include or may be determining and updating states of the object, for example the location of the object, the heading angle of the object, and/or the type of the object (for example car, truck, bicycle, pedestrian, building, or static road obstacle),

The update of the state of the object may be carried out if and only if the second parameter is assigned to the object. The update of the state of the object may not be carried out if the first parameter is assigned to the object (but instead, re-initialization may be carried out).

The prediction may be carried out irrespective of whether the first parameter or the second parameter is assigned.

Only one parameter may be assigned to the object at a time. In other words, either the first parameter or the second parameter (or the third parameter) may be assigned to the object. Thus, assignment of the first parameter may be deleted upon assigning the second parameter to the object.

The method provides improved tracking (in other words: state estimation, for example estimation of position, velocity, acceleration, or heading angle), in particular at the beginning of object existence (i.e. in an early stage of the tracking of the object, i.e. in a stage at which the object has not been tracked for a long time).

In the re-initialization, more aggressive changes of estimated parameters may be made as compared to the (Kalman) update step. In other words, the (full) Kalman filter may not be started immediately after the object is being created (in other words: detected for the first time).

Thus, after a few iterations, the estimated state may be of good quality. The effect of incorrect initial state estimates may be reduced through the whole life of the object.

According to another aspect, the computer implemented method further comprises the following steps carried out by the computer hardware components: determining whether measurement data can be associated with the object; and assigning a third parameter to the object if the measurement data cannot be associated with the object.

The third parameter may be referred to a “coasted”. For example, if the measurement data cannot be associated with the object (or vice versa, the object cannot be associated with the measurement data), the object may be treated as behaving in a smooth (or continuous or steady or differentiable) manner, and the update of the state of the object may be carried out on the assumption of this manner.

According to another aspect, the re-initializing is based on carrying out measurements related to the object. The measurement may be further measurements. The re-initialization may change the state of the object to a larger extent than a conventional Kalman filter update step would change the state of the object.

According to another aspect, the computer implemented method further comprises the following step carried out by the computer hardware components: determining whether a first condition is fulfilled based on the re-initializing.

The criterion related to the first condition may be referred to as “soft” criterion.

According to another aspect, the computer implemented method further comprises the following step carried out by the computer hardware components: responsive to determining the first condition is fulfilled, assigning the second parameter to the object.

According to another aspect, the computer implemented method further comprises the following step carried out by the computer hardware components: responsive to determining the first condition is not fulfilled, determining whether a second condition is fulfilled.

The criterion related to the second condition may also be referred to as a hard criterion.

According to another aspect, the second condition is based on computational resources available for the tracking of the object. With the second condition based on computational resources, it may be ensured that the computational resources are sufficient for the tasks to be carried out. For example, tracking objects with the first parameter assigned may be computationally more expensive than tracking objects with the second parameter assigned, so that assigning the second parameter to the object to be tracked may provide relief from computational efforts.

According to another aspect, the second condition is based on a time since the first parameter was assigned to the object. With the second condition based on a time since the first parameter was assigned to the object (i.e. a time since the object was first detected), wherein the time may for example be expressed in terms of seconds, or may be expressed in number of iterations of the tracking, it may be ensured that an object does not have the first parameter assigned for too long time. If an object would be assigned the first parameter for too long time, this may be an indication of a misdetection of the object, so that it may be preferred to disregard the object from tracking or to subject the object to full Kalman filtering (including the update step of the Kalman filter).

According to another aspect, the computer implemented method further comprises the following step carried out by the computer hardware components: responsive to determining the second condition is fulfilled, determining whether assignment of the second parameter is possible. This determination may be a further check to determine whether there is enough good measurements to transit object to mature state in order to avoid creating low quality objects (for example to check if the object was de-aliased).

According to another aspect, the computer implemented method further comprises the following step carried out by the computer hardware components: responsive to determining assignment of the second parameter is not possible, ignoring the object.

Ignoring the object may be understood as not further tracking the object (for example, by deleting the object from a list of objects to be tracked). If the assignment is possible, then the second parameter may be assigned to the object.

According to another aspect, various steps of the computer implemented method are carried out iteratively (in other words: repeatedly; in other words: in a loop with one or more of the steps of the method).

According to another aspect, wherein the prediction and the update are comprised in a Kalman filter. In other words, the prediction may be a prediction step of a Kalman filter, and the update may be an update step of the Kalman filter.

For example, the method according to various embodiments may be applied to a Kalman filter as described in European Patent Application EP20166800, which is incorporated herein by reference in its entirety.

In another aspect, the present disclosure is directed at a computer system, said computer system comprising a plurality of computer hardware components configured to carry out several or all steps of the computer implemented method described herein. The computer system can be part of a vehicle.

The computer system may comprise a plurality of computer hardware components (for example a processor, for example processing unit or processing network, at least one memory, for example memory unit or memory network, and at least one non-transitory data storage). It will be understood that further computer hardware components may be provided and used for carrying out steps of the computer implemented method in the computer system. The non-transitory data storage and/or the memory unit may comprise a computer program for instructing the computer to perform several or all steps or aspects of the computer implemented method described herein, for example using the processing unit and the at least one memory unit.

In another aspect, the present disclosure is directed at a vehicle, comprising at least a portion of the computer system.

In another aspect, the present disclosure is directed at a non-transitory computer readable medium comprising instructions for carrying out several or all steps or aspects of the computer implemented method described herein. The computer readable medium may be configured as: an optical medium, such as a compact disc (CD) or a digital versatile disk (DVD); a magnetic medium, such as a hard disk drive (HDD); a solid state drive (SSD); a read only memory (ROM), such as a flash memory; or the like. Furthermore, the computer readable medium may be configured as a data storage that is accessible via a data connection, such as an internet connection. The computer readable medium may, for example, be an online data repository or a cloud storage.

The present disclosure is also directed at a computer program for instructing a computer to perform several or all steps or aspects of the computer implemented method described herein.

### BRIEF DESCRIPTION OF THE DRAWINGS

Exemplary embodiments and functions of the present disclosure are described herein in conjunction with the following drawings, showing schematically:

FIG. 1 an illustration of a relationship between an amount of data available for initialization and an accuracy of initial estimates;

FIG. 2 a flow diagram illustrating a method of updating a state of a tracked object without use of a “young” parameter;

FIG. 3 a flow diagram illustrating a method for updating a state of a tracked object with use of a “young” parameter according to various embodiments; and

FIG. 4 a flow diagram illustrating a method for tracking an object according to various embodiments.

### DETAILED DESCRIPTION

Tracking methods, for example in radar domain (for example based on radar sensor data) may be based on system modeling and time/measurement filtration or filtering (for example based on a Kalman filter).

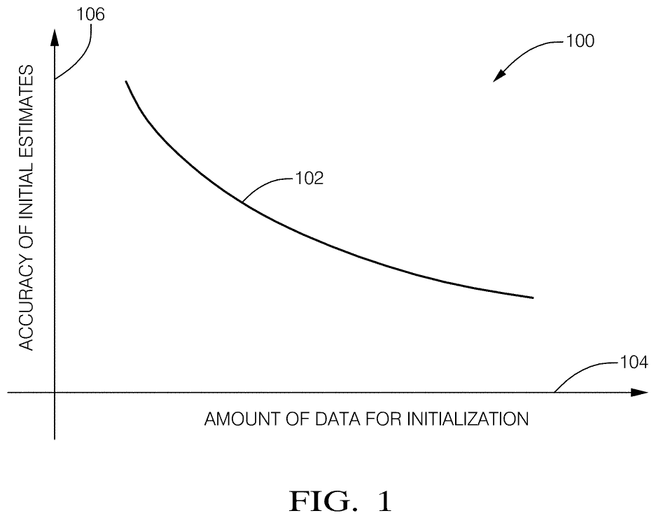

Kalman filters in general do not require initial estimates to be calculated, but in active safety domain, it may be desired to provide initial estimates. Missing initial estimates may lead to long time of convergence of estimated values to real values. For that reason, it may be desired for tracking methods to estimate some initial states of a system at the beginning of the tracking process and then handling them by time and measurement updates afterwards. In general, a tendency can be observed that the more data is available for initialization estimate, then more accurate initial parameter can be estimated, as illustrated in FIG. 1.

FIG. 1 shows an illustration 100 of a relationship (or tendency) between an amount of data available for initialization (indicated on a horizontal axis 104) and an accuracy of initial estimates (indicated on a vertical axis 106). The relationship is indicated by curve 102.

Once an object (for example object to be tracked) is detected (and a data structure for tracking the object has been created), then the object (or the data structure) is updated by consecutive measurements. It may be observed that when an object is initialized with state variables (for example velocities, positions, and/or heading angles) with poor accuracy, then it may take a significant amount of time for the Kalman filter to converge the estimated parameters to (or close to) the true values. This may cause the creation of ghost objects and splits or objects that suffer from poor estimation (for example poor heading (angle) estimation) through the whole life (i.e. the whole tracking) of the object. In active safety applications, this may lead to situations that such objects trigger false or late alerts, for example in feature functions like rear collision traffic alerts or lane change assist.

Furthermore, it may be desired in active safety applications that the tracking object is created as soon as possible, so that gathering data for a longer time may not be acceptable. Therefore, in conventional methods, there may be a trade-off between either creating objects late with better accuracy or creating objects more quickly with worse accuracy.

In various situations, it may not be possible to get better initial state estimation, but it may only be possible to delay the initialization to increase the number of detections, but this may result in late object creation which is not preferable. Furthermore, once the object is created, then only slow correction of the state (in other words: tracking data, for example heading) of the objects is available when the state (for example heading) of the object is initialized incorrectly. It may be preferable to have smooth state estimation (for example heading estimation) without overshoots, so that once an object is corrected, the Kalman filter is making slow correction of the state (for example heading). This may lead to incorrect estimation of the state for the whole life of objects or can be the root cause of ghost objects. In conventional methods, the object status may be considered mature from the first moment.

Assumption-based methods for initialization may be provided. The selection between different methods may, for example, depend on the position, velocity, heading of the target object, yaw rate, and/or velocity of the host vehicle. In this way, the type of maneuver or scenario is being identified. Depending on the results of the selection, a different set of equations may be applied for calculation of initial state variables. For example, when the host is stationary and detections from radar from consecutive scans creates a line perpendicular to the host orientation, then lateral assumption (linear regression) is applied. Similarly, when the host is driving straight and detections from the target object are observed as driving in this same direction as the host is driving, then longitudinal assumption may be applied.

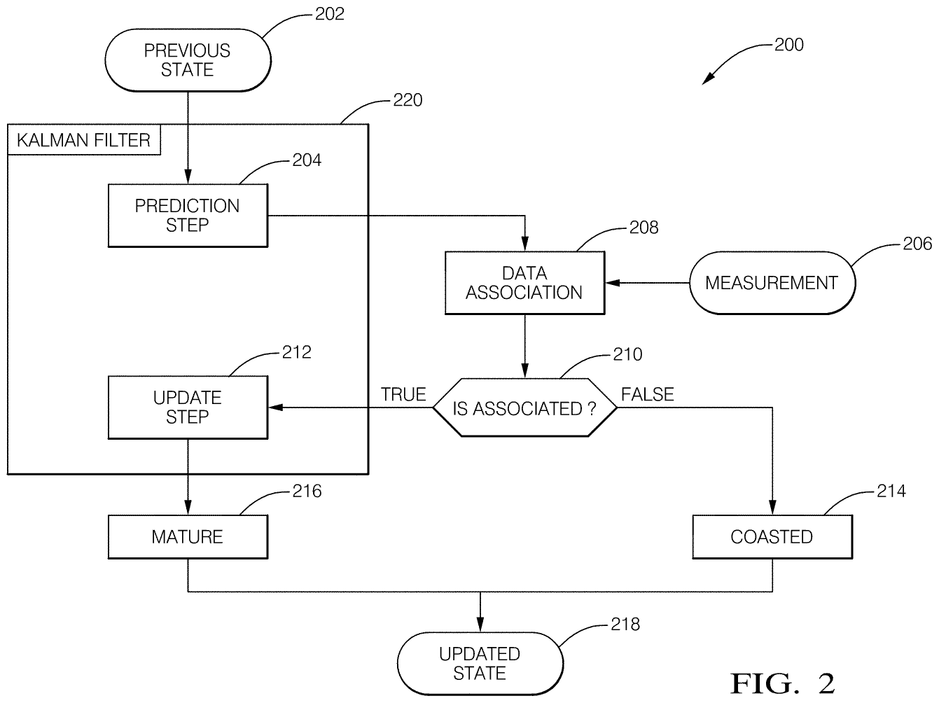

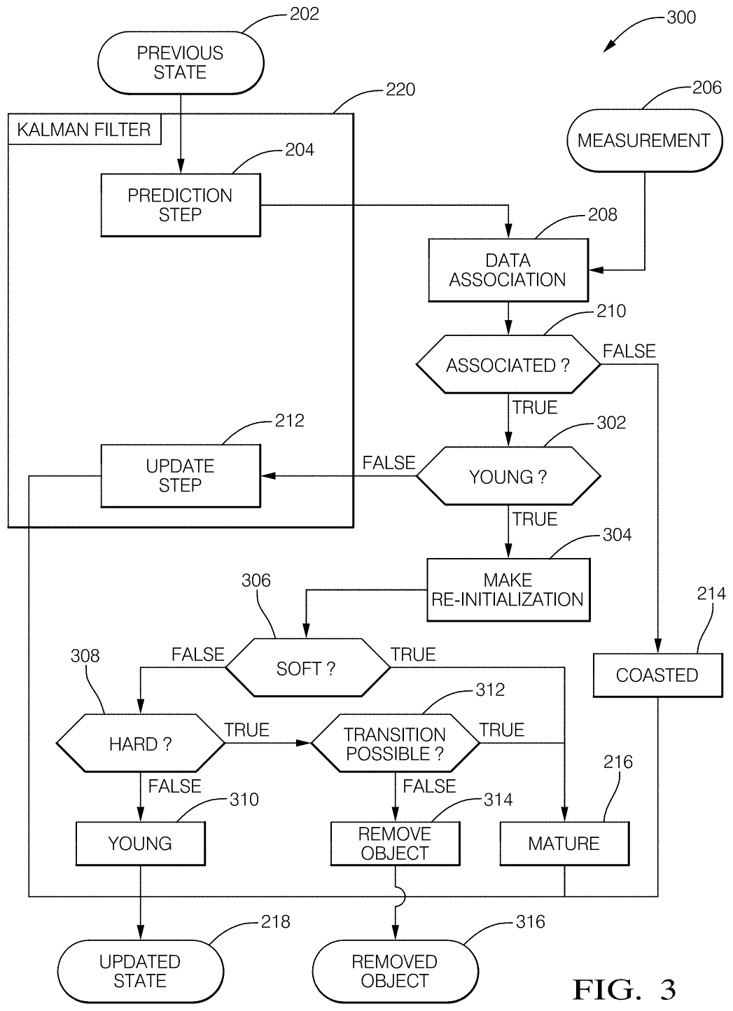

FIG. 2 shows a flow diagram 200 illustrating a method (for example radar tracker method) of updating a state of a tracked object without use of a “young” parameter (FIG. 3 below will illustrate a method with the use of a “young” parameter). Starting from a previous state 202 (which may be an initial state or a random state upon the first execution of the updating), a prediction step 204 may be carried out. Data association 208 may be performed after the prediction step 204 and based on measurement data 206. At 210, it may be determined whether the tracked object can be associated with measurement data 206.

If the object cannot be associated with the measurement data 206, then this may be for example due to the object being temporarily obstructed (i.e. not visible in the measurement data 206), and the object may be treated as coasting in step 214, in order to obtain the updated state 218 assuming a continuing (for example smooth) advance in the state (for example without taking into account the measurement data 206).

If the object can be associated with the measurement data 206, an update step 212 is carried out (for example based on the measurement data 206) in order to obtain the updated state 218, and then the object is treated as mature (216).

The updated state 216 may be taken as previous state 202 for a subsequent iteration of the update method illustrated in FIG. 2.

The prediction step 204 and the update step 212 may be steps of a Kalman filter 220 (or may define or may be the Kalman filter).

FIG. 3 shows a flow diagram 300 illustrating a method for updating a state of a tracked object with use of a “young” parameter according to various embodiments. Various steps of the method illustrated in FIG. 3 are identical or similar to steps of the method illustrated in FIG. 2, so that the same reference signs may be used, and duplicate description may be omitted.

If it is determined in step 210 that the measurement data 206 can be associated with the object, then it is determined whether the object is “young” in step 302 (in other words, it is determined whether the status of the object is “young”; in other words: it is determined whether the parameter “young” is assigned to the object).

If the object is not “young”, then the update step 212 is carried out. It will be understood that the determination 302 also provides the result that the object is not “young” if the object is coasted (from the previous iteration). In such a situation, the status of the object may be set to “mature”.

At step 304, re-initialization may be performed, for example by involving further measurement data, and by giving the further measurement data more weight or more influence compared to measurement data used in the update step 212 (in other words: the re-initialization 304 may change the state more aggressively than the update step 212).

For example, at each cycle when the update step 212 is performed, then the object state is corrected only by measurement from the current cycle (without using measurements from previous cycles for the updated). Thus, the updated state may be obtained only based on filtering, which is calibrated to be smooth to prevent sharp jumps of objects states.

In case of the re-initialization 304, all the measurements (of the present cycle and one or more of the preceding cycles, for example in form of an array) gathered so far are used to do initialization again. This may lead to abrupt jump in object states, but those states may be closer to the real object.

It will be understood that a cycle may refer to one run of the steps illustrated in FIG. 3, and may also be referred to as one iteration (for example in a method of iteratively repeating the method illustrated in FIG. 3).

At 306, it may be determined whether a first criterion (which may be referred to as a “soft” criterion) is met. If the first criterion is met, the object status may be set to “mature” at step 216 (in other words, the parameter “mature” may be assigned to the object). If the first criterion is not met, processing may proceed at step 308.

The first criterion (“soft” criterion) may be provided to speed up object initialization. Each time when the object is re-initialized (or just initialized), additional checks are performed to verify if current parameters of object are good enough to leave status “young”. For example, the first criterion may be related to acceptable estimated variance of the state (or each component of the state) of the object. If the variance is low enough, then the tracker may carry out the transition from “young” to “mature” in step 216.

At 308, it may be determined whether a second criterion (which may be referred to as a “hard” criterion) is met. If the second criterion is not met, then the object may stay in a “young” status (step 310). If the second criterion is met, then processing may proceed at step 312.

The second criterion may be used to check if the tracker does not extend software and hardware limitations. The second criterion may for example be related to free space in buffer for gathering measurement data, or an upper limit of number of cycles (or iterations) that object is in status “young” to avoid keeping an object in this status forever. Once the tracker passes the second criterion, it must be decided (for example in step 312) whether to keep the object (and proceed to status “mature”) or to remove the object.

At 312, it may be determined whether a transition to status “mature” is possible for the object. If transition to status “mature” is possible, then the status of the object may be set to “mature” in 216. If transition to status “mature” is not possible, then the object may be removed from tracking in 314, so as to result in that the object is removed 316.

The first criterion may be provided to speed up object creation, but the requirements of the first criterion for that are more restricted than the second criterion. Thus, it may be possible to create an object with status “mature” because of reaching the second criterion, even though its estimated state would not pass the first criterion.

The method illustrated in FIG. 3 may exceed the performance of the method illustrated in FIG. 2, in particular at the beginning of object creation (i.e. in a stage in which objects are just started to being tracked, so that the (initial) state estimates may not be very accurate yet).

The method illustrated in FIG. 2 operates on only two statuses (in other words: with one of two parameters), on object level, and the parameters are “mature” and “coasted”. Once the object is created, in the method of FIG. 2, its status is “mature”. It can be changed to “coasted” in case when there is no measurement data (in other words: when measurement data 206 may not be associated with the object).

An object in status “mature” 216 is fully updated by Kalman filter (prediction step and update step) and in status “coasted” 214 it can be only predicted (due to the lack of measurement, which means that only the prediction step 204 can be performed).

Thus, if an object is wrongly initialized (for example regarding position, heading, and/or velocities), it may take longer time to get correct estimated parameters with the method of FIG. 2 than with the method of FIG. 3.

With the method of FIG. 3, the tracker (i.e. the system carrying out the method illustrated in FIG. 3) may perform re-initialization by adding a new status (which may be called “young”). When the object is created, then the tracker may set the object status to “young”. At each next cycle, when the object is in this status, no Kalman update is performed, but additional measurement is collected and then re-initialization of object is done with this additional measurement. This may allow the tracker for a more aggressive update of the object and may give the tracker more chance for better object initialization.

The object may keep the status “young” until the tracker decides to change it to “mature” or “coasted”. Two types of criteria may be provided to make this decision: “soft” and “hard”, as described above.

It will be understood that “status” is different from “state”. “Status” refers to the parameter assigned to an object (for example “young”, “mature”, or “coasted”). “State” refers to the state of the object, for example the linear velocity, angular velocity, heading angle, height, speed, and/or acceleration.

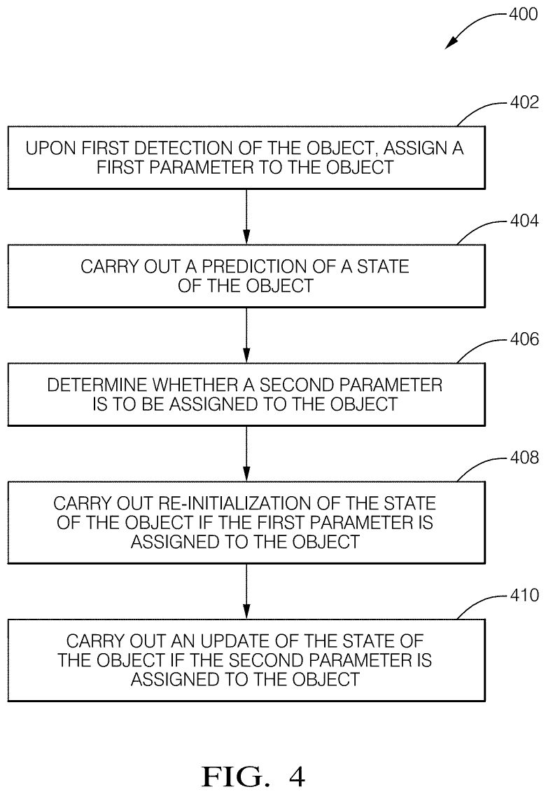

FIG. 4 shows a flow diagram 400 illustrating a method for tracking an object according to various embodiments. At 402, upon first detection of the object, a first parameter may be assigned to the object. At 404, a prediction of a state of the object may be carried out. At 406, it may be determined whether a second parameter is to be assigned to the object. At 408, re-initialization of the state of the object may be carried out if (e.g., responsive to determining) the first parameter is assigned to the object. At 410, an update of the state of the object may be carried out if (e.g., responsive to determining) the second parameter is assigned to the object.

According to various embodiments, it may be determined whether measurement data can be associated with the object, and a third parameter may be assigned to the object in response to determining the measurement data cannot be associated with the object.

According to various embodiments, the re-initializing may be based on carrying out measurements related to the object.

According to various embodiments, it may be determined whether a first condition is fulfilled based on the re-initializing.

According to various embodiments, responsive to determining the first condition is fulfilled, the second parameter may be assigned to the object.

According to various embodiments, responsive to determining the first condition is not fulfilled, it may be determined whether a second condition is fulfilled.

According to various embodiments, the second condition may be based on computational resources available for the tracking of the object.

According to various embodiments, the second condition may be based on a time since the first parameter was assigned to the object.

According to various embodiments, responsive to determining the second condition is fulfilled, it may be determined whether assignment of the second parameter is possible.

According to various embodiments, responsive to determining assignment of the second parameter is not possible, the object may be ignored.

According to various embodiments, various steps of the method may be carried out iteratively.

According to various embodiments, the prediction and the update may be included in a Kalman filter.

Each of the steps 402, 404, 406, 408, 410 and the further steps described above may be performed by computer hardware components.

What is claimed is:

1. A method, comprising
tracking, by computer hardware components, an object by at least:
responsive to receiving a first detection of the object, assigning a first parameter to the object;
predicting a state of the object;
determining whether a second parameter is to be assigned to the object;
re-initializing the state of the object in response to determining the first parameter is assigned to the object; and
updating the state of the object in response to determining the second parameter is assigned to the object.

2. The method of claim 1, wherein tracking the object further comprises:
determining whether measurement data can be associated with the object; and
assigning a third parameter to the object in response to determining the measurement data cannot be associated with the object.

3. The method of claim 1, wherein re-initializing the state of the object comprises re-initializing the state of the object based on measurements related to the object.

4. The method of claim 1, wherein tracking the object further comprises:
determining whether a first condition is fulfilled based on the re-initializing.

5. The method of claim 4, wherein tracking the object further comprises:
responsive to determining the first condition is fulfilled, assigning the second parameter to the object.

6. The method of claim 4, wherein tracking the object further comprises:
responsive to determining the first condition is not fulfilled, determining whether a second condition is fulfilled.

7. The method of claim 6, wherein the second condition is based on computational resources available for the tracking of the object.

8. The method of claim 6, wherein the second condition is based on a time since the first parameter was assigned to the object.

9. The method of claim 6, wherein tracking the object further comprises:
responsive to determining the second condition is fulfilled, determining whether assignment of the second parameter is possible.

10. The method of claim 9, wherein tracking the object further comprises:
responsive to determining assignment of the second parameter is not possible, ignoring the object.

11. The method of claim 9, wherein various steps of the tracking the object are carried out iteratively.

12. The method of claim 1, wherein predicting the state of the object and updating the state of the object comprise using a Kalman filter to determine the state of the object.

13. A system, comprising:
a computer system having computer components configured to track an object by at least:
responsive to receiving a first detection of the object, assigning a first parameter to the object;
predicting a state of the object;
determining whether a second parameter is to be assigned to the object;
re-initializing the state of the object in response to determining the first parameter is assigned to the object; and
updating the state of the object in response to determining the second parameter is assigned to the object.

14. The system of claim 13, further comprising a vehicle comprising at least a portion of the computer components of the computer system.

15. A non-transitory computer readable medium comprising instructions, that, when executed, configure computer components of a system to track an object by at least:
responsive to receiving a first detection of the object, assigning a first parameter to the object;
predicting a state of the object;
determining whether a second parameter is to be assigned to the object;
re-initializing the state of the object in response to determining the first parameter is assigned to the object; and
updating the state of the object in response to determining the second parameter is assigned to the object.

16. The non-transitory computer readable medium of claim 15, wherein the instructions, when executed, further configure the computer system to track the object by:
determining whether measurement data can be associated with the object; and
assigning a third parameter to the object in response to determining the measurement data cannot be associated with the object.

17. The non-transitory computer readable medium of claim 15, wherein the instructions, when executed, further configure the computer system to re-initialize the state of the object based on measurements related to the object.

18. The non-transitory computer readable medium of claim 15, wherein the instructions, when executed, further configure the computer system to track the object by determining whether a first condition is fulfilled based on the re-initializing.

19. The non-transitory computer readable medium of claim 18, wherein the instructions, when executed, further configure the computer system to track the object by:
responsive to determining the first condition is fulfilled, assigning the second parameter to the object.

20. The non-transitory computer readable medium of claim 18, wherein the instructions, when executed, further configure the computer system to track the object by:
responsive to determining the first condition is not fulfilled, determining whether a second condition is fulfilled.
